(19) United States
(12) Patent Application Publication
(10) Pub. No.: US 2026/0054874 A1
(43) Pub. Date: Feb. 26, 2026

(54) Using a Trained Machine-Learning Model for Efficient Packing of Items

(71) Applicant: Maplebear Inc., San Francisco, CA (US)

(72) Inventors: Brent Scheibelhut, Toronto (CA); Bryan Pham, London (CA); Charles Wesley, San Diego, CA (US); Mark Oberemk, Toronto (CA); Naval Shah, Toronto (CA)

(21) Appl. No.: 18/814,368

(22) Filed: Aug. 23, 2024

(51) Int. Cl. B65B 35/50; G06Q 10/083; G06T 19/00

(52) U.S. Cl. CPC B65B 35/50; G06Q 10/083; G06T 19/006

(57) ABSTRACT

An online system uses a trained machine-learning model for efficient packing of items. Upon receiving, from a device of an agent or a device of a source via a network, a signal indicating that a set of items are ready for packing, the online system applies the machine-learning model to identify, based at least in part on input data, a packing order for one or more items of the set of items. Based on the identified packing order for the one or more items, the online system generates a packing interface signal. The online system sends the packing interface signal, wherein sending the packing interface signal causes the one or more items to be packed according to the identified packing order. This process is repeated until it is confirmed that all items from the set of items were packed.

### BACKGROUND

Inefficient packing of items leads to damage of items, inefficiency, etc. Therefore, it is desirable to automatically and at a large scale, as required by an online system that offers items for sale, optimize packing of items.

### SUMMARY

Embodiments of the present disclosure are directed to using a trained machine-learning model of an online system for efficient packing of items.

In accordance with one or more aspects of the disclosure, the online system receives, from a device of an agent associated with an online system or a device of a source associated with the online system via a network, a signal indicating that a set of items are ready for packing. The online system obtains, from at least one of the device of the agent or the device of the source and via the network, input data including information about at least one of the set of items, the agent, or the source. In response to the received signal, the online system accesses a packing order machine-learning model of the online system, wherein the packing order machine-learning model is trained to identify a packing order for one or more items of the set of items. The online system applies the packing order machine-learning model to identify, based at least in part on the input data, the packing order for the one or more items. The online system generates, based on the identified packing order for the one or more items, a packing interface signal. The online system sends the packing interface signal, wherein sending the packing interface signal causes the one or more items to be packed according to the identified packing order.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates an example architectural flow diagram of using a trained machine-learning model of an online system for efficient packing of items, in accordance with one or more embodiments.

FIG. 4 illustrates an example user interface generated based on an output of a machine-learning model of an online system trained to identify an optimal packing for a set of items, in accordance with one or more embodiments.

FIG. 5 is a flowchart for a method of using a trained machine-learning model of an online system for efficient packing of items, in accordance with one or more embodiments.

### DETAILED DESCRIPTION

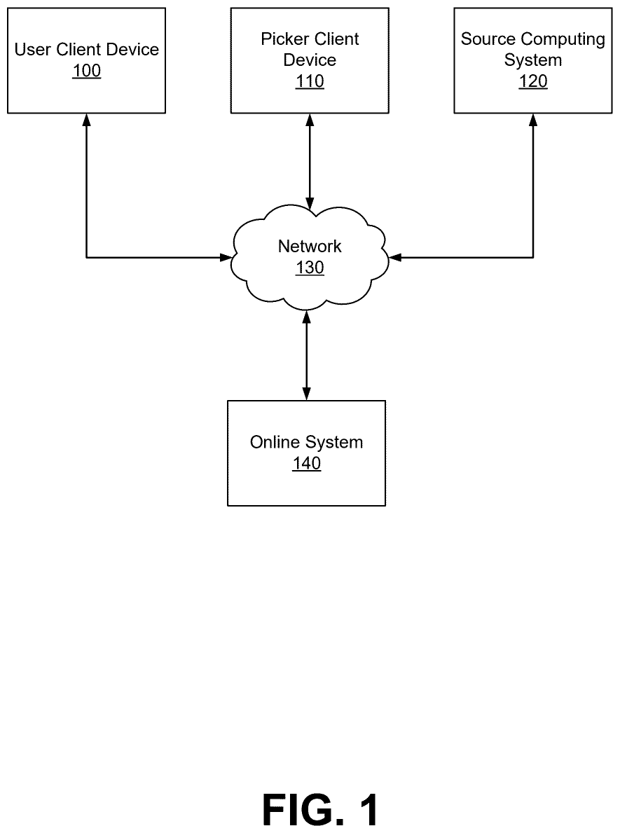

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker (fulfillment agent or agent) services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 helps users pack items (e.g., into a bag, trunk, or staging area) to optimize for picking time, avoiding damage to items, etc. The online system 140 trains a model (e.g., machine-learning model) that determines an optimal packing order for a set of items, where the packing order is based on item features, bag features, and feedback about a current state of the packed items. The online system 140 then displays the packing order to an in-store user of the online system 140, a picker associated with the online system 140, or a user of a source associated with the online system 140. The online system 140 may be further interfaced to include an artificial reality (AR) device, which obtains the current state of the packed items and provides the packing instructions as an AR overlay.

In one or more embodiments, the online system 140 utilizes a trained predictive model (e.g., machine-learning model) and optimization rules to determine optimal packing arrangement of a set of items. The online system 140 may show the optimal packing arrangement in an AR overlay, or otherwise in a user interface of the online system 140 and/or in a display of a source associated with the online system 140.

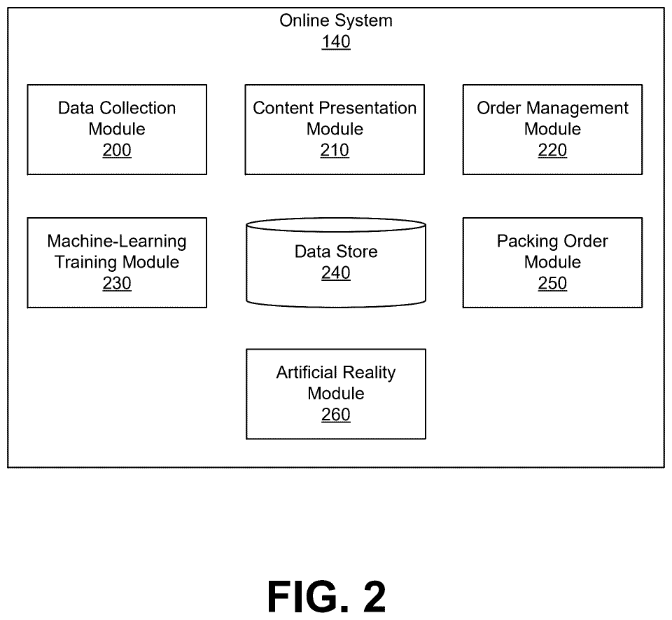

The online system 140 may create an optimal packing plan for pickers and/or users at checkout in source locations, or within staging areas associated with the online system 140. This optimal packing plan may be leveraged by humans or robotic packaging systems and may optimize bags and box usage to reduce waste both in terms of spend and bags/boxes used. The optimal packing plan created by the online system 140 may also aim to reduce damage (e.g., not placing heavy items on eggs), cross contamination (e.g., not packing meat with vegetables) and weight of each bag/box (e.g., avoid having 60 lbs. of cans in one bag/box). Users shopping in source locations, users of the online system 140 that conduct in-store shopping, and/or pickers associated with the online system 140 may get an AR overlay of the orientation and position an item should be placed. Additionally, employees at staging areas associated with the online system 140 may get an AR overlay of where in the shelf to place the bag or box of items. Furthermore, the optimal packing plan created by the online system 140 can be exceedingly useful for shopping at certain source locations where there are a large number of big and bulky items. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, a packing order module 250, and an artificial reality module 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The packing order module 250 may access a packing order model (e.g., machine-learning model) that is trained to determine a packing order for a set of items. The packing order module 250 may deploy the packing order model to run a machine-learning algorithm to output, based on a set of inputs, the packing order for the set of items. The packing order may be provided as a next item or a next group of items for packing in a bag, box, in-store shopping cart, or a staging area in a source location. A set of parameters for the packing order model may be stored at one or more non-transitory computer-readable media of the packing order module 250. Alternatively, the set of parameters for the packing order model may be stored at one or more non-transitory computer-readable media of the data store 240.

The packing order module 250 may provide the set of inputs representing various input features to the packing order model that are required for the packing order model to deduce the optimal packing plan. In providing the set of inputs to the packing order model, the packing order module 250 may provide information about item features (e.g., size, weight, fragility, toughness, etc.), information about a batch of items that a picker associated with the online system 140 has been tasked with, information about bag (or box) features (e.g., size limit, weight limit, etc.), information about types of bags/boxes available in a source location, features of the picker who is currently fulfilling the batch of orders, an AR video feed, some other data that can facilitate packing of items, or some combination thereof.

In providing the set of inputs to the packing order model, the packing order module 250 may provide information about a relative toughness of an item in an order, so that the machine-learning algorithm of the packing order model would know where to place the item in a stack. The relative toughness of the item may be initially inferred from a taxonomy node of the item that can be retrieved (e.g., via the packing order module 250) from an item catalog database stored, e.g., at the data store 240. For example, produce is typically more fragile than canned goods.

In providing the set of inputs to the packing order model, the packing order module 250 may provide information about types of bags and/or boxes available in the source location and/or dimensions of a shopping cart in the source location. This information may be deduced from knowledge of the bags offered by the source location along with scans of a box area at the source location prior to the picker beginning to shop (or in real time as other pickers pass by the box area), as well as knowledge of the shopping cart offered by the source location. The input to the packing order model with information about types of bags and/or boxes may be on a per source per bag/box type. Furthermore, a strength of each bag/box type may be rated in terms of two dimensions, i.e., resistance to weight (e.g., estimated maximum weight) and tensile strength (e.g., ability to withstand sharp or dense items). The online system 140 may obtain information about types of bags and/or boxes and dimensions of the shopping cart from the source computing system 120 and/or one or more picker client devices 110 via the network 130.

In providing the set of inputs to the packing order model, the packing order module 250 may provide information about a weight limit and/or size limit of each bag and/or box. The weight limit and/or the size limit each bag/box may be based on information about preferences of a particular picker who is fulfilling a current order and/or a user of the online system 140 who placed the order. For example, if the picker prefers or could handle heavy bags and boxes, the maximum weight that one bag or one box could hold may be set to be higher by the online system 140 (e.g., the packing order module 250). However, in some cases, the maximum weight may not be increased as the user who was being shopped for (and who had to bring the bag or box inside from their porch) had preferences for lighter baggage.

The packing order model may identify which item from the set of items is a next item to pack. When the set of items are ready to be packed, the packing order module 250 may deploy the packing order model to run a machine-learning algorithm on the set of inputs to identify a next item of the set of items to pack. Alternatively, the packing order model may identify what is a next group of items to pack, such as a next layer of items to stack in a bag. The packing order model may pass data with information about the next item (or the next group of items) for packing to the content presentation module 210. The content presentation module 210 may then cause a user interface of the picker client device 110 or a user interface of the user client device 100 to display the identified next item (or the next group of items) for packing. Alternatively, the packing order module 250 may communicate, via the network, data with information about the next item (or the next group of items) for packing to the source computing system 120. The source computing system 120 may then cause a user interface of a display device in a source location to display the next item (or the next group of items) for packing. Once it is confirmed that the item was packed (e.g., by the picker via the user interface of the picker client device 110, by the user via the user interface of the user client device 100, or an in-store user via the user interface of the display device in the source location), the item packing process may be repeated to pack a next item identified by the packing order model, until all items in the order are packed.

In one or more embodiments, the packing order model passes data with information about the next item (or the next group of items) for packing to the artificial reality module 260. The artificial reality module 260 may then cause, based on the received data, an AR imagery (e.g., display of an AR headset worn by a picker or in-store user) to display the item within the bag or box once the item has been picked up by the picker or the in-store user. Once the bag or box is full, the artificial reality module 260 may then cause the AR imagery to display where to place the bag or box within the smart shopping cart or the staging area in the source location.

The machine-learning algorithm run by the packing order model may operate within a three-dimensional space-both in terms of ingesting the set of input (e.g., size and shape of item, size of box/bag, size of cart, current layout of the staging area, etc.) and the output (e.g., where to place the bag, box, or item). With respect to placing the item into the bag itself, the machine-learning algorithm run by the packing order model may generate an output identifying that round items that are less likely to break the bag should be placed on the side of the bag, whereas sharp or pointy items should be placed either in stretchy bags or boxes.

The machine-learning training module 230 may perform initial training of the packing order model using training data. The machine-learning training module 230 may generate the training data by gathering data with information about actual observed placement of items in a bag. The data with information about actual observed placement of items in the bag may be gathered in the source location (e.g., via computer vision or sensors in the source location) and then communicated from the source computing system 120 to the online system 140 via the network 130. Alternatively or additionally, the machine-learning training module 230 may generate the training data by gathering data with information about a score (e.g., success score) for the bag/box packing, based on metrics such as packing speed, appeasements (i.e., damage to items), etc. The data with information about the score for bag/box packing may be gathered in the source location by a picker associated with the online system 140, in-store user or employee of the source and communicated from the picker client device 110, the user client device 100 or the source computing system 120 to the online system 140 via the network 130. The machine-learning training module 230 may train the packing order model using the training data to generate initial values for the set of parameters of the packing order model.

In one or more embodiments, the machine-learning training module 230 utilizes cold start data for training the packing order model to generate initial values for the set of parameters of the packing order model. The cold start data may be gathered based on inputs about packing of items from pickers and/or in-store users who are utilizing AR-enabled devices. Alternatively or additionally, the cold start data may be gathered based on information on how pickers and in-store users are currently packing their items. Alternatively or additionally, the cold start data may be gathered by manually labelling a collection of batches of items. The manual labeling may be achieved, e.g., by “packing” each batch in the three-dimensional space (or some other coordinate system) utilized by the AR device (e.g., AR headset) ahead of time in order to understand what the optimal space would be given a default bag size, default cart size, and average box available in the source location. Additionally or alternatively, the cold start data may be gathered based on ratings/feedback from pickers and/or in-store users, such as explicit positive and/or negative feedback about smart bagging.

In one or more embodiments, the output from the packing order model identifying a next item (or next group of items) for packing can be utilized by in-store users to pack bags. Alternatively or additionally, the output from the packing order model identifying a next item (or next group of items) for packing may be utilized by employees in the source location.

Alternatively or additionally, the output from the packing order model identifying a next item (or next group of items) for packing may be utilized by pickers associated with the online system 140 to pack items as well as to put bags and bulky items in a car's trunk. Alternatively or additionally, the output from the packing order model identifying a next item (or next group of items) for packing may be utilized as an input signal for a robotic packing system in the source location that is interfaced with the online system 140 via the network 130. The robotic packing system in the source location may pack the next item (or next group of items) according to the output of the packing order model.

In one or more embodiments, based on the output of the packing order model, the packing order module 250 communicates to a picker associated with the online system 140 or an in-store user (e.g., via a user interface of the picker client device 110, a user interface of a display device in the source location, or a display of AR device) a signal with recommendation about a number of bags that should be used for packing of items in an order (e.g., given the type of bags available in the source location) as well as with information what items should be placed in each bag. In this manner, the online system 140 may provide an optimal packing plan that minimizes waste and directs the recipient either via the AR device or a segment list on the user interface. Hence, the online system 140 presented herein may avoid providing a packing situation to in-store users who generally do not appreciate bad bagging choices (e.g., mixing items in the same bag that don't belong, such as frozen items with warm items, or cleaning supplies with loose produce, etc.). The online system 140 presented herein may also provide an added benefit for in-store users to use an in-store application of the online system 140 running on the user client devices 100. The online system 140 presented herein may also help minimizing bag cost to in-store users, and in-store users can provide inputs on how much they care (or don't) about their baggage preferences. If in-store users extremely care about bag cost, the packing order model may be trained to optimize packing of all items into one bag. In contrast, if the in-store users care more about item separation, the packing order model may be trained to respect their baggage preferences while increasing the bag cost.

In one or more embodiments, the online system 140 integrating the packing order model may allow a picker associated with the online system 140 to take a picture of their trunk and then utilize that input image to help place bags from orders so that during drop offs the picker would not lose track of which order should be delivered to which user of the online system 140. The trunk space may be mapped similarly to how the inside of a cart is mapped. For example, a picker associated with the online system 140 had recently shopped a batch of orders that includes three individual orders placed by three different users of the online system 140 and a total of ten bags. Traditionally, the picker had to keep remembering which order and which bags were being delivered to which user. However, if the picker had utilized the output of the packing order model of the online system 140 to place the bags within the trunk, the picker may utilize their camera and AR imagery to just point at the bags and have the application of the online system 140 running on the picker client device 100 directs them to which bag corresponds to which order.

In one or more embodiments, the online system 140 integrating the packing order model facilitates isolating orders from a batch of orders as well as order confirmation. Given that the packing order model knows what items belong to which order in the batch of orders when deducing the optimal packing plan for each order within the batch, the online system 140 presented herein may allow a picker associated with the online system 140 to take a picture of items in a batch and show at a user interface of the picker client device 110 which order an item was from. For example, the picker may have a leftover loaf of bread and have no idea which order this item belonged to. By utilizing the user interface of the picker client device 110 in communication with the online system 140 that integrates the packing order model, the picker can identify which order the bread belonged to. Similarly, for the drop-off picture that the picker is required to take for part of a batch that belongs to a specific user of the online system 140, the user interface of the picker client device 110 in communication with the online system 140 that integrates the packing order model can see visible items and confirm those items are indeed for an order that belongs to the specific user.

The machine-learning training module 230 may collect data with information about an actual way that a collection of users of the online system 140 packed the bags. The data with information about actual observed placement of items in the bags by the collection of users may be gathered in source locations (e.g., via computer vision or sensors in the source locations) and then communicated from the source computing systems 120 to the online system 140 via the network 130. Labels may be assigned to the collected data based on success of packing, including damage to items, satisfaction of users, etc. The machine-learning training module 230 may then re-train the packing order model by updating the set of parameters of the packing order model using the collected data.

Additionally of alternatively, the machine-learning training module 230 may re-train the packing order model by utilizing feedback from a picker associated with the online system 140 and a user of the online system 140 concerning weight of bags/boxes, ease of use, speed of packing in the formatted manner, and the constant imagery from AR-enabled devices during packing. If the packing order model had potentially over-optimized on the weight and use of bags but that negatively affected the speed at which the picker could pack items, the machine-learning training module 230 may utilize this feedback to re-train the packing order model to adjust an output for future similar orders.

Additionally of alternatively, the machine-learning training module 230 may re-train the packing order model by utilizing feedback from pickers associated with the online system 140 and/or users of the online system 140 about any damages to items that occurred when applying the packing plan identified by the packing order model. For example, if the picker or an in-store user had placed an item in a bag that was identified as a “tough” item, but a number of pickers or users reported that the item was breaking or not tough (e.g., the identified “tough” item was regularly broken or bruised), the machine-learning training module 230 may utilize these reports for re-training of the packing order model. Hence, overall, the packing order model may be configured as a reinforcement learning model.

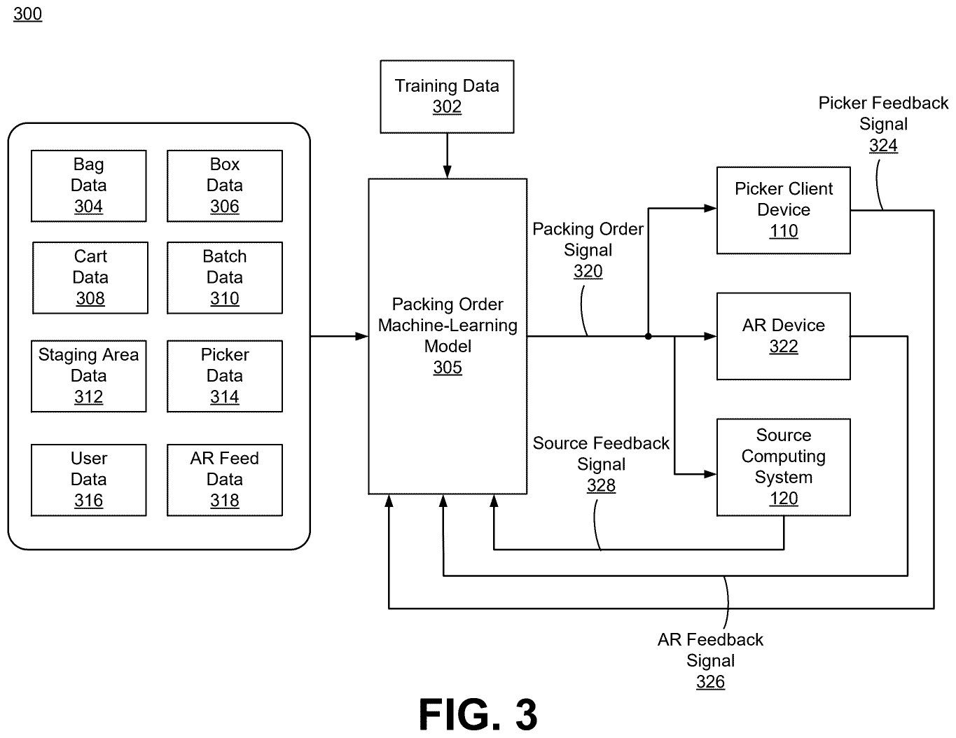

FIG. 3 illustrates an example architectural flow diagram 300 of using a packing order machine-learning model 305 of the online system 140 for efficient packing of items, in accordance with one or more embodiments. First, the online system 140 may perform (e.g., via the machine-learning training module 230) initial training of the packing order machine-learning model 305 using training data 302 to generate initial values for the set of parameters of the packing order machine-learning model 305. The training data 302 may be generated (e.g., via the machine-learning training module 230) by gathering data with information about actual observed placement of items in bags and/or boxes, data with information about the packing speed, data with information about any damage occurred to items during the packing, etc. After the training process is completed, the online system 140 may provide various inputs to the packing order machine-learning model 305 (e.g., via the packing order module 250), such as bag data 304, box data 306, cart data 308, batch data 310, staging area data 312, picker data 314, user data 316 and/or AR feed data 318. Some additional input features not shown in FIG. 3 suitable for identifying the optimal order for packing of items may be further provided to the packing order machine-learning model 305.

In providing the set of inputs to the packing order machine-learning model 305, the packing order module 250 may further provide the bag data 304 with information about a bag fee and/or a bag type in a source location. In providing the set of inputs to the packing order machine-learning model 305, the packing order module 250 may further provide the box data 306 with information about box types and/or box sizes in the source location. In providing the set of inputs to the packing order machine-learning model 305, the packing order module 250 may further provide the cart data 308 with information about dimensions of a shopping cart in the source location. The bag data 304, the box data 306 and the cart data 308 may be received at the online system 140 (e.g., via the packing order module 250) from the source computing system 120 via the network 130.

In providing the set of inputs to the packing order machine-learning model 305, the packing order module 250 may further provide the batch data 310 with information about a batch of orders that are being fulfilled by a picker associated with the online system 140, including features of items (e.g., types of items, weights of items, quantity of items, item sizes, etc.) of each order in the batch of orders. The batch data 310 may be received at the online system 140 (e.g., via the packing order module 250) from the picker client device 110 via the network 130.

In providing the set of inputs to the packing order machine-learning model 305, the packing order module 250 may further provide the staging area data 312 with information about dimensions of a staging area in the source location and/or dimensions of a staging area in a trunk of a picker's vehicle. The staging area data 312 may be gathered through a computer vision or sensors of the staging area in the source location and may be received at the online system 140 (e.g., via the packing order module 250) from the source computing system 120 via the network 130. Alternatively or additionally, the staging area data 312 may be gathered by the picker taking a picture of the trunk via a user interface of the picker client device 110 and may be received at the online system 140 (e.g., via the packing order module 250) from the picker client device 110 via the network 130.

In providing the set of inputs to the packing order machine-learning model 305, the packing order module 250 may further provide the picker data 314 with information about characteristics of the picker who is currently fulfilling the batch of orders. The packing order module 250 may retrieve the picker data 314 from a picker catalog database stored at, e.g., the data store 240.

In providing the set of inputs to the packing order machine-learning model 305, the packing order module 250 may further provide the user data 316 with information about characteristics of users whose orders that belong to the batch of orders are currently being fulfilled. The packing order module 250 may retrieve the user data 316 from a user catalog database stored at, e.g., the data store 240.

In providing the set of inputs to the packing order machine-learning model 305, the packing order module 250 may further provide the AR feed data 318 with information about a current state of packed items, a current state of empty space in bags/boxes, etc. The AR feed data may be received at the online system 140 (e.g., via the packing order module 250) from an AR device 322 (e.g., worn by the picker) via the network 130.

The packing order machine-learning model 305 may apply a machine-learning algorithm to the bag data 304, box data 306, cart data 308, batch data 310, staging area data 312, picker data 314, user data 316 and/or AR feed data 318 to output a packing order signal 320 with information about a packing order for a set of items in the batch of orders. The packing order signal 320 may be a digital signal with information about which item from the set of items is a next item to pack. Alternatively, the packing order signal 320 may be a digital signal with information about what is a next group of items to pack, such as a next layer of items to stack in a bag or box. The packing order signal 320 output by the packing order machine-learning model 305 may be communicated to the picker client device 110, the AR device 322 and/or the source computing system 120 via the network 130.

The packing order signal 320 may cause (e.g., via the content presentation module 210) a user interface of the picker client device 110 to display the next item that is scheduled for packing or a next layer of items that are scheduled for packing, so that the picker can utilize the interface to view what is the next item or the next layer of items scheduled for packing. Similarly, the packing order signal 320 may cause (e.g., via the content presentation module 210) a display of the AR device 322 (e.g., worn by the picker or in-store user) to display the next item that is scheduled for packing or a next layer of items that are scheduled for packing, so that the picker or the in-store user can utilize the AR overlay to view what is the next item or the next layer of items scheduled for packing. Similarly, the packing order signal 320 may cause (e.g., via the content presentation module 210) a display of the source computing system 120 in the source location to display the next item that is scheduled for packing or a next layer of items that are scheduled for packing, so that an employee in the source location or an in-store user can utilize the displayed information to view what is the next item or the next layer of items scheduled for packing.

The picker client device 110 may record a picker feedback signal 324 with information about weights of bags/boxes after packing, ease of use of the displayed packing plan, speed of packing in the formatted manner, any damages to items that occurred when applying the packing plan identified by the packing order machine-learning model 305, etc. The online system 140 may receive (e.g., via the machine-learning training module 230) the picker feedback signal 324 from the picker client device 110 via the network 130. The machine-learning training module 230 may utilize the picker feedback signal 324 to re-train the packing order machine-learning model 305. By utilizing the picker feedback signal 324, the machine-learning training module 230 may update the set of parameters of the packing order machine-learning model 305 and continuously improve the machine-learning algorithm of the packing order machine-learning model 305.

The AR device 322 may record an AR feedback signal 326 with information about speed of packing in the formatted manner, any damages to items that occurred when applying the packing plan identified by the packing order machine-learning model 305, or any other packing information captured by one or more sensors (e.g., one or more cameras) of the AR device 322 worn by the picker or the in-store user. The online system 140 may receive (e.g., via the machine-learning training module 230) the AR feedback signal 326 from the AR device 322 via the network 130. The machine-learning training module 230 may utilize the AR feedback signal 326 to re-train the packing order machine-learning model 305. By utilizing the AR feedback signal 326, the machine-learning training module 230 may update the set of parameters of the packing order machine-learning model 305 and continuously improve the machine-learning algorithm of the packing order machine-learning model 305.

The source computing system 120 may record a source feedback signal 328 with information about weights of bags/boxes after packing conducted by the employee in the source location or the in-store user, ease of use of the displayed packing plan, speed of packing in the formatted manner, any damages to items that occurred when applying the packing plan identified by the packing order machine-learning model 305, etc. The online system 140 may receive (e.g., via the machine-learning training module 230) the source feedback signal 324 from the source computing system 120 via the network 130. The machine-learning training module 230 may utilize the source feedback signal 328 to re-train the packing order machine-learning model 305. By utilizing the source feedback signal 328, the machine-learning training module 230 may update the set of parameters of the packing order machine-learning model 305 and continuously improve the machine-learning algorithm of the packing order machine-learning model 305.

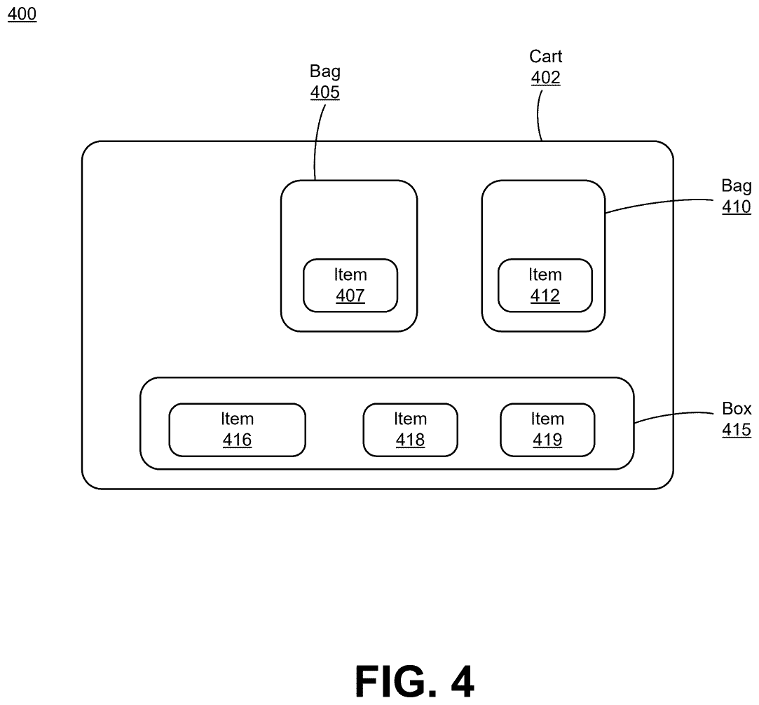

FIG. 4 illustrates an example user interface 400 generated based on the packing order signal 320 output by the packing order machine-learning model 305, in accordance with one or more embodiments. The user interface 400 may be a user interface of the picker client device 110, a user interface of the user client device 100, a user interface of the AR device 322 and/or a user interface of the source computing system 120. The user interface 400 may be continually updated to display a next item in a cart 402 for packing, and the cart 402 may eventually include all items in an order of a batch of orders.

For example, the user interface 400 may first display a bag 405 with a first item 407 to pack in the bag 405. Once it was confirmed (e.g., via corresponding button of the user interface 400) that the first item 407 was packed in the bag 405, the user interface 400 may display a next bag 410 with a next item to pack in the bag 410, i.e., an item 412. Once it was confirmed that the item 412 was packed in the bag 410, the user interface 400 may display a box 415 with a next item to pack in the box 415, i.e., an item 416. Once it was confirmed that the item 416 was packed in the box 415, the user interface 400 may display a next item to pack in the box 415, i.e., an item 418. Finally, once it was confirmed that the item 418 was packed in the box 415, the user interface 400 may display a last item to pack in the box 415, i.e., an item 419, which is also a last item in the order to be packed.

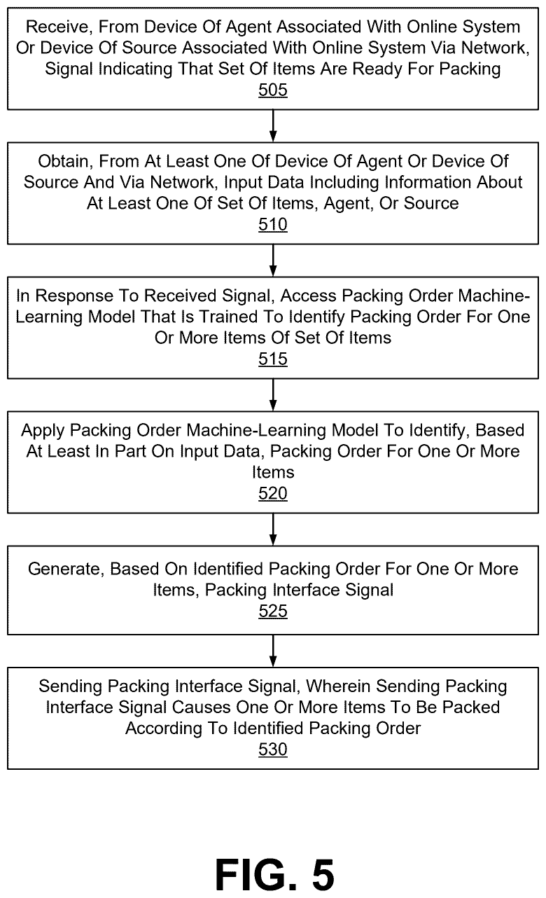

FIG. 5 is a flowchart for a method of using a trained machine-learning model of an online system to efficiently package items, in accordance with one or more embodiments. Alternative embodiments may include more, fewer, or different steps from those illustrated in FIG. 5, and the steps may be performed in a different order from that illustrated in FIG. 5. These steps may be performed by an online system (e.g., the online system 140). Additionally, each of these steps may be performed automatically by the online system without human intervention.

The online system 140 receives 505 (e.g., via the packing order module 250), from a device of an agent (e.g., the picker client device 110) associated with the online system 140 or a device of a source (e.g., the source computing system 120) associated with the online system 140 via a network (e.g., the network 130), a signal indicating that a set of items are ready for packing. The online system 140 obtains 510 (e.g., via the packing order module 250), from at least one of the device of the agent or the device of the source and via the network, input data including information about at least one of the set of items, the agent, or the source.

The online system 140 may receive (e.g., via the packing order module 250), from the device of the source via the network, the input data including information about one or more features of bags available in a location of the source. Alternatively or additionally, the online system 140 may receive (e.g., via the packing order module 250), from the device of the agent via the network, the input data including information about at least one of a size of each item of the set of items, a weight of each item of the set of items, or a fragility of each item of the set of items. Alternatively or additionally, the online system 140 may receive (e.g., via the artificial reality module 260), from an AR device worn by the agent and via the network, the input data including AR video data with information about at least one of an available empty space of a staging area in the location of the source or an available empty space of a trunk in a vehicle of the agent. The online system 140 may update (e.g., via the packing order module 250) the input data based at least in part on the AR video data.

In response to the received signal, the online system 140 accesses 515 a packing order machine-learning model of the online system 140 (e.g., via the packing order module 250), wherein the packing order machine-learning model is trained to identify a packing order for one or more items of the set of items. The online system 140 applies 520 (e.g., via the packing order module 250) the packing order machine-learning model to identify, based at least in part on the input data, the packing order for the one or more items.

The online system 140 generates 525 (e.g., via the content presentation module 210), based on the identified packing order for the one or more items, a packing interface signal. The online system 140 sends 530 (e.g., via the content presentation module 210) the packing interface signal, wherein sending the packing interface signal causes the one or more items to be packed according to the identified packing order.

The online system 140 may send (e.g., via the content presentation module 210), via the network, the packing interface signal to the device of the agent or to the device of the source causing a user interface of the device of the agent or a user interface of the device of the source to display the one or more items for packing. The online system 140 may display (e.g., via the content presentation module 210), based on the packing interface signal, the one or more items for packing on a display of an AR device worn by the agent.

The online system 140 may receive (e.g., via the packing order module 250), via the user interface of the device of the agent or the user interface of the device of the source, a first confirmation signal indicating that the one or more items were packed. In response to the first confirmation signal, the online system 140 may apply the packing order machine-learning model (e.g., via the packing order module 250) to identify, based at least in part on the input data, a packing order for one or more next items of the set of items. The online system 140 may generate (e.g., via the content presentation module 210), based on the identified packing order for the one or more next items, an updated packing interface signal. The online system 140 may causes (e.g., via the content presentation module 210), based on the updated packing interface signal, the user interface of the device of the agent or the user interface of the device of the source to display the one or more next items for packing. The online system 140 may receive (e.g., via the packing order module 250), via the user interface of the device of the agent or the user interface of the device of the source, a second confirmation signal indicating that the one or more next items were packed.

The online system 140 may send, via the network, the packing interface signal to a robotic packing system causing the robotic packing system to pack the one or more items according to the identified packing order. Additionally, the online system 140 may send, via the network, the updated packing interface signal to the robotic packing system causing the robotic packing system to pack the one or more next items after the one or more items. Hence, the robotic packing system may pack the set of items in an order identified by the packing order machine-learning model.

Data with information about observed placement of items in one or more bags may gathered via at least one of a computer vision or one or more sensors in a location of the source. The online system 140 may receive (e.g., via the machine-learning training module 230), from the device of the source via the network, the gathered data. The online system 140 may train (e.g., via the machine-learning training module 230), using the gathered data, the packing order machine-learning model to generate a set of initial values for the set of parameters of the packing order machine-learning model.

The online system 140 may receive (e.g., via the machine-learning training module 230), from at least one of the device of the agent or the device of the source via the network, data with information about a speed of packing a collection of items or one or more damages that occurred to one or more items of the collection of items during packing. The online system 140 may generate training data by assigning (e.g., via the machine-learning training module 230), based on the received data, a success score to packing of each item of the collection of items. The online system 140 may train (e.g., via the machine-learning training module 230), using the training data, the packing order machine-learning model to generate a set of initial values for the set of parameters of the packing order machine-learning model.

Data with information about actual observed packing of the set of items may be gathered via at least one of a computer vision or one or more sensors in a location of the source. The online system 140 may receive (e.g., via the machine-learning training module 230), from the device of the source via the network, the gathered data. The online system 140 may re-train the packing order machine-learning model by updating (e.g., via the machine-learning training module 230), using the gathered data, the set of parameters of the packing order machine-learning model.

The online system 140 may generate feedback data by assigning (e.g., via the machine-learning training module 230) a label based on information about at least one of one or more damages occurred to the one or more items of the set of items during packing or feedback from a user of the online system 140 upon the packed set of items were delivered to the user. The online system 140 may re-train the packing order machine-learning model by updating (e.g., via the machine-learning training module 230), using the feedback data, the set of parameters of the packing order machine-learning model.

Embodiments of the present disclosure are directed to the online system 140 that utilizes a trained machine-learning model to predict a preferred packing order for a set of items, which is then displayed at a user interface of the online system 140. The user interface with the preferred packing order may be displayed at a user interface of the picker client device 110, a user interface of the source computing system 120 and/or a display of an AR device, which facilitates receiving feedback on real-time packing status. The user interface of the picker client device 110, the user interface of the source computing system 120 and/or the display of the AR device may be utilized to indicate where items should optimally be placed when packing a bag, box, or shopping cart.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, from a device of an agent associated with an online system or a device of a source associated with the online system via a network, a signal indicating that a set of items are ready for packing;
obtaining, from at least one of the device of the agent or the device of the source and via the network, input data including information about at least one of the set of items, the agent, or the source;
in response to the received signal, accessing a packing order machine-learning model of the online system, wherein the packing order machine-learning model is trained to identify a packing order for one or more items of the set of items;
applying the packing order machine-learning model to identify, based at least in part on the input data, the packing order for the one or more items;
generating, based on the identified packing order for the one or more items, a packing interface signal; and
sending the packing interface signal, wherein sending the packing interface signal causes the one or more items to be packed according to the identified packing order.

2. The method of claim 1, wherein sending the packing interface signal comprises:
sending, via the network, the packing interface signal to the device of the agent or to the device of the source causing a user interface of the device of the agent or a user interface of the device of the source to display the one or more items for packing.

3. The method of claim 2, further comprising:
receiving, via the user interface of the device of the agent or the user interface of the device of the source, a first confirmation signal indicating that the one or more items were packed;
in response to the first confirmation signal, applying the packing order machine-learning model to identify, based at least in part on the input data, a packing order for one or more next items of the set of items;
generating, based on the identified packing order for the one or more next items, an updated packing interface signal;
causing, based on the updated packing interface signal, the user interface of the device of the agent or the user interface of the device of the source to display the one or more next items for packing; and
receiving, via the user interface of the device of the agent or the user interface of the device of the source, a second confirmation signal indicating that the one or more next items were packed.

4. The method of claim 2, wherein displaying the one or more items for packing comprises:
displaying, based on the packing interface signal, the one or more items for packing on a display of an artificial reality (AR) device worn by the agent.

5. The method of claim 1, wherein sending the packing interface signal comprises:
sending, via the network, the packing interface signal to a robotic packing system causing the robotic packing system to pack the one or more items according to the identified packing order.

6. The method of claim 1, wherein obtaining the input data comprises:
receiving, from the device of the source via the network, the input data including information about one or more features of bags available in a location of the source.

7. The method of claim 1, wherein obtaining the input data comprises:
receiving, from the device of the agent via the network, the input data including information about at least one of a size of each item of the set of items, a weight of each item of the set of items, or one or more other features of each item of the set of items.

8. The method of claim 1, wherein obtaining the input data comprises:
receiving, from an artificial reality (AR) device worn by the agent and via the network, the input data including AR video data with information about at least one of an available empty space of a staging area in a location of the source or an available empty space of a trunk in a vehicle of the agent; and
updating the input data based at least in part on the AR video data.

9. The method of claim 1, further comprising:
gathering, via at least one of a computer vision or one or more sensors in a location of the source, data with information about observed placement of items in one or more bags;
receiving, from the device of the source via the network, the gathered data; and
training, using the gathered data, the packing order machine-learning model to generate a set of initial values for a set of parameters of the packing order machine-learning model.

10. The method of claim 1, further comprising:
receiving, from at least one of the device of the agent or the device of the source via the network, data with information about at least one of a speed of packing a collection of items, or one or more damages that occurred to one or more items of the collection of items during packing;
generating training data by assigning, based on the received data, a score to packing of each item of the collection of items; and
training, using the training data, the packing order machine-learning model to generate a set of initial values for a set of parameters of the packing order machine-learning model.

11. The method of claim 1, further comprising:
gathering, via at least one of a computer vision or one or more sensors in a location of the source, data with information about actual observed packing of the set of items;
receiving, from the device of the source via the network, the gathered data; and
re-training the packing order machine-learning model by updating, using the gathered data, a set of parameters of the packing order machine-learning model.

12. The method of claim 1, further comprising:
generating feedback data by assigning a label based on information about at least one of one or more damages occurred to the one or more items of the set of items during packing or feedback from a user of the online system upon the packed set of items were delivered to the user; and
re-training the packing order machine-learning model by updating, using the feedback data, a set of parameters of the packing order machine-learning model.

13. A computer program product comprising a non-transitory computer readable storage medium having instructions encoded thereon that, when executed by a processor, cause the processor to perform steps comprising:
receiving, from a device of an agent associated with an online system or a device of a source associated with the online system via a network, a signal indicating that a set of items are ready for packing;
obtaining, from at least one of the device of the agent or the device of the source and via the network, input data including information about at least one of the set of items, the agent, or the source;
in response to the received signal, accessing a packing order machine-learning model of the online system, wherein the packing order machine-learning model is trained to identify a packing order for one or more items of the set of items;
applying the packing order machine-learning model to identify, based at least in part on the input data, the packing order for the one or more items;
generating, based on the identified packing order for the one or more items, a packing interface signal; and
sending the packing interface signal, wherein sending the packing interface signal causes the one or more items to be packed according to the identified packing order.

14. The computer program product of claim 13, wherein the instructions further cause the processor to perform steps comprising at least one of:
sending, via the network, the packing interface signal to the device of the agent or to the device of the source causing a user interface of the device of the agent or a user interface of the device of the source to display the one or more items for packing.

15. The computer program product of claim 14, wherein the instructions further cause the processor to perform steps comprising at least one of:
receiving, via the user interface of the device of the agent or the user interface of the device of the source, a first confirmation signal indicating that the one or more items were packed;
in response to the first confirmation signal, applying the packing order machine-learning model to identify, based at least in part on the input data, a packing order for one or more next items of the set of items;
generating, based on the identified packing order for the one or more next items, an updated packing interface signal;
causing, based on the updated packing interface signal, the user interface of the device of the agent or the user interface of the device of the source to display the one or more next items for packing; and
receiving, via the user interface of the device of the agent or the user interface of the device of the source, a second confirmation signal indicating that the one or more next items were packed.

16. The computer program product of claim 14, wherein the instructions further cause the processor to perform steps comprising at least one of:
displaying, based on the packing interface signal, the one or more items for packing on a display of an artificial reality (AR) device worn by the agent.

17. The computer program product of claim 13, wherein the instructions further cause the processor to perform steps comprising at least one of:
sending, via the network, the packing interface signal to a robotic packing system causing the robotic packing system to pack the one or more items according to the identified packing order.

18. The computer program product of claim 13, wherein the instructions further cause the processor to perform steps comprising at least one of:
receiving, from an artificial reality (AR) device worn by the agent and via the network, the input data including AR video data with information about at least one of an available empty space of a staging area in a location of the source or an available empty space of a trunk in a vehicle of the agent; and
updating the input data based at least in part on the AR video data.

19. The computer program product of claim 13, wherein the instructions further cause the processor to perform steps comprising at least one of:
receiving, from at least one of the device of the agent or the device of the source via the network, data with information about at least one of a speed of packing a collection of items, or one or more damages that occurred to one or more items of the collection of items during packing;
generating training data by assigning, based on the received data, a score to packing of each item of the collection of items;
training, using the training data, the packing order machine-learning model to generate a set of initial values for a set of parameters of the packing order machine-learning model;
gathering, via at least one of a computer vision or one or more sensors in a location of the source, data with information about actual observed packing of the set of items;
receiving, from the device of the source via the network, the gathered data; and
re-training the packing order machine-learning model by updating, using the gathered data, the set of parameters of the packing order machine-learning model.

20. A computer system comprising:
a processor; and
a non-transitory computer-readable storage medium having instructions that, when executed by the processor, cause the computer system to perform steps comprising:
receiving, from a device of an agent associated with an online system or a device of a source associated with the online system via a network, a signal indicating that a set of items are ready for packing;
obtaining, from at least one of the device of the agent or the device of the source and via the network, input data including information about at least one of the set of items, the agent, or the source;
in response to the received signal, accessing a packing order machine-learning model of the online system, wherein the packing order machine-learning model is trained to identify a packing order for one or more items of the set of items;
applying the packing order machine-learning model to identify, based at least in part on the input data, the packing order for the one or more items;
generating, based on the identified packing order for the one or more items, a packing interface signal; and
sending the packing interface signal, wherein sending the packing interface signal causes the one or more items to be packed according to the identified packing order.
